(19) United States
(12) Patent Application Publication
(10) Pub. No.: US 2012/0047004 A1
(43) Pub. Date: Feb. 23, 2012

(54) SEQUENCED VIDEO OVERLAY ADVERTISEMENTS, INCLUDING USER-INTERACTIVE PUZZLES

(75) Inventor: Mehul Sanghavi, Sunnyvale, CA (US)

(73) Assignee: Yahoo! Inc., Sunnyvale, CA (US)

(21) Appl. No.: 13/286,170

(22) Filed: Oct. 31, 2011

Related U.S. Application Data
(63) Continuation of application No. 12/611,247, filed on Nov. 3, 2009.

(51) Int. Cl. G06Q 30/02

(52) U.S. Cl. 705/14.1; 705/14.73

(57) ABSTRACT

The present invention provides methods and systems for advertising in connection with a video segment. Methods are provided in which a time-spaced sequence of video overlay advertisements are displayed. Advertisements of the sequence may be user-interactive and may relate to subject matter of the video segment displayed during display of the advertisements. Advertisements of the sequence may be user-interactive, and may provide pieces of a puzzle. A final advertisement may provide a reward, which may include, for example, a completed puzzle or an opportunity to complete the puzzle, and possibly other content or rewards.

### CROSS-REFERENCE TO PRIORITY APPLICATION

This application is a continuation of U.S. application Ser. No. 12/611,247, filed on Nov. 3, 2009, entitled, “SEQUENCED VIDEO OVERLAY ADVERTISEMENTS”.

### BACKGROUND

Online video content continues to grow in practicality, popularity, importance and length. Users find video content entertaining and engaging for significant periods of time. Along with the popularity and user engagement level of video content comes great advertising potential. However, due in part to the high level of user engagement, existing types of advertising in connection with video content tend to get ignored by users, or otherwise perform poorly in terms of various measures including catching the user's attention, engagement and interaction levels, click through rates, conversion rates, etc.

There is a need for advertising techniques in connection with videos, including better-performing advertising techniques.

### SUMMARY OF THE INVENTION

Some embodiments of the invention provide methods and systems for advertising in connection with a video segment (including all forms of video and portions thereof, such as online video forms including downloaded or streaming video, television, etc.). Methods are provided in which a time-spaced sequence of video overlay (including partial overlay) advertisements are displayed. Advertisements of the sequence may be user-interactive and may relate to subject matter of the video segment displayed during display of the advertisements. A later one or more advertisements of the sequence may relate to, or tie together, each of several of the preceding advertisements of the sequence, and may be provided as part of, or may help provide, a reward to the user for interaction with each of the several preceding advertisements. In some embodiments, advertisements of the sequence are user-interactive, and one or more later advertisements in the sequence may be selected, modified, or customized based in part on user interaction with an earlier one or more advertisements. As such, embodiments of the invention can greatly enhance monetization in connection with advertising, videos, Web sites including videos, etc.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a simplified depiction of a sequence of advertisements according to one embodiment of the invention; and

FIG. 5 is a simplified depiction of a sequence of advertisements according to one embodiment of the invention.

While the invention is described with reference to the above drawings, the drawings are intended to be illustrative, and the invention contemplates other embodiments within the spirit of the invention.

### DETAILED DESCRIPTION

As used herein, the term “advertisement” is intended to broadly include advertisements of any of various types, forms and formats, whether direct or indirect, and whether or not intermingled or mixed with non-advertising elements.

The term “overlay advertisement”, as used herein, is broadly intended to include any advertisement with any overlay element, even if other non-overlay advertisement portions or elements are also included.

The term “reward”, as used herein, is intended to broadly include, among other things, any of various desirable outcomes for a user, whether or not conditional, speculative or uncertain, and including informational or other incentives. For example, rewards can include access, codes or content unlock codes to premium content, coupons or coupon codes, image or music downloads, points or other incentives associated with a publisher, etc. Rewards can also include such things as an opportunity not to receive advertisements or certain advertisements, or other freedoms or privileges, whether positive or negative in nature. Rewards can further include anything of benefit, such as tangible benefit, to a user. In some embodiments of the invention, rewards are conditioned on some form of user interaction, and the promise or possibility of rewards lead to greater user engagement, interest, and curiosity.

Sequenced overlay advertisements, according to some embodiments, provide a new type of advertisement format in connection with video segments, and lead to high user engagement. Furthermore, rewards at or toward the end of a sequence further encourage user participation. Greater user engagement can lead to better advertisement performance, including, for example, higher click through rates and conversion rates. This can in turn lead to greater profitability and return on investment for advertisers, publishers, and other involved parties, and encourage greater advertiser spend. Additionally, greater and ongoing user engagement leads to greater probability of the user to continue viewing or interacting with the video segment, Web page, etc. Embodiments of the invention are particularly valuable given the value, and cost, to advertisers of advertising in connection with videos, such as cost per million impressions, or CPM. The high value of advertising in connection with videos also provides incentive for advertisers to provide rewards for user interaction or participation. Furthermore, sequenced advertising according to embodiments of the invention can provide publishers as well as advertisers with new sales packaging models, particularly with regard to premium content. This can include, for example, rewards that may include access to such premium content, such as free, limited, introductory or discounted access.

In some embodiments, sequences may connect together in any of various ways, such as by including steps or elements of a larger set, such as an information set or game. Integrated information or result information may be presented or included in one or more final advertisements or graphical user interfaces.

In some embodiments, sequenced advertisements can provide or create visually appealing partial stories or storyboards, in addition to providing various contextually relevant and appealing elements, which can include images or other graphical elements. Such storyboards (including partial storyboards) can, in some embodiments, be affected and at least in part guided by user interaction. In some embodiments, advertisements of a sequence may, with user interaction, provide parts or pieces of a puzzle or other larger item, and users may be allowed, called on or invited to assemble, or interact in the assembly of, the pieces, for example, during or at the conclusion of a video.

In some embodiments, storyboarding or storyboarding-related sequences can be used to essentially paint a story around product benefits or product use cases, all in an interactive, engaging, visually appealing and potentially rewarding way. In some embodiments, user interaction with some or any of the storyboard elements can lead to a browser being opened to a Web site associated with the product, or a further advertisement sequence or advertisement video, etc.

In some embodiments, a final advertisement of a sequence may provide users with some form of reward for interaction with some or all previous advertisements in the sequence. Accordingly, such a final advertisement and reward may be conditioned upon user interaction with one or more previous advertisements of the sequence. This fact may be explicit or implied to the user, or the user may be aware of it through repeated experience. A final advertisement or graphical user interface may also provide the user with options, including options relating to the reward or alternative rewards.

In some embodiments, advertisements of a sequence may be numbered, such as “1 of 3”, etc., so that the user knows or is sure to know that it is part of a sequence. Furthermore, in some embodiments, overlay advertisements are marked in some way as being advertisements, so as to prevent user confusion.

Rewards, according to embodiments of the invention, can vary. As one example, a reward may include presenting a user with information including results of previous advertisements of the sequence, and of user interaction with such advertisements, which may include integrated and additional information. For instance, a sequence may include advertisements that each relate to a different incremental step in a recipe. User interaction with all or each such advertisement can result in a reward. The reward may include a full recipe, including each of the steps from previous advertisements. The recipe may include additional information regarding the recipe, beyond the steps. User interaction may guide the sequence and the reward, for instance, by allowing users to choose the recipe in an early advertisement, or customize the recipe. Furthermore, after a user receives a reward, the user may be more likely to participate in other advertisement sequences.

In some embodiments, each time a user interacts, the user may be presented with increasingly valuable information. For example, a sequence may relate to steps in “how-to” guidance, and user interaction can lead to steps, such as increasingly valuable steps, in the guidance being revealed.

In another embodiment, advertisements of a sequence can relate to a game for user participation. The game could be of any type, such as a trivia game, sweepstakes, etc., and may be associated with the video sequence. Some games can compare a user's performance with previous performance of other users, or may even include simultaneous online gaming elements. For example, a user's performance can be compared against that of other users who may have viewed the sequence previously or who are currently viewing the sequence. Some embodiments provide content-relevant quizzes or quips which call upon the user to actively engage with advertisement elements and provide input.

In some embodiments, advertisements of a sequence can include elements of a larger puzzle, requiring user interaction to continue or develop, etc. A final advertisement or graphical user interface could include the assembled or completed puzzle, for example, or assembly, integration, or completion of some other sort. Of course, there are many other possibilities.

In some embodiments, user interaction with advertisements of the sequence can cause or lead to further presentations or opportunities for engagement, whether along with, in parallel with, or separately from the video segment. For example, a user click or other behavior could cause a separate browser to open, or could cause a daughter window or microsite to occur or open, or could lead to additional further associated overlay advertisements, etc.

Various embodiments of the invention can be used with online video, including pre-roll or post-roll advertising as well as non-linear advertising, overlay or bug advertising, etc. Furthermore, advertisements of a sequence can include advertisements that fall into more than one such category. Some embodiments of the invention are used in connection with a long form (LF) video playback.

Overlay advertisements according to embodiments of the invention can be timed, placed, or sequenced in many different ways. For instance, in some embodiments, overlay advertisements of a sequence can be timed so as to occur at regular or irregular intervals throughout a video, which spacing may be based at least in part on a duration of the video, or may be placed to coincide with particular video content. In some embodiments, placement can be dynamic, and based at least in part on user interaction. Furthermore, in some embodiments, placement can be based at least in part on targeting or user history, which can include, for example, a user's history with regard to viewing video content, or playback data logs associated with the user.

In some embodiments, topics or content of sequences or advertisements of sequences are associated with, or considered to be complimentary to, one or more topics associated with the video segment. Furthermore, even if a topic of a sequence and a topic of a video segment are not related, the topics may be planned so as to be likely to be complimentary with respect to user interests, such that users interested in one topic may have a relatively high likelihood of being interested in the other topic. Furthermore, in some embodiments, advertisements of a sequence may be strategically placed during portions of a video segment for which active user attention or engagement is likely to be high. Still further, placement may be based at least in part on specific cue points in a video where, for example, there may be relatively little interference with the video.

In some embodiments, each of several overlay advertisements of a sequence are presented simultaneously with a portion or time segment of a video segment with which it is most related or complimentary. For example, if a certain time segment of a video includes a particular person or place, an advertisement, of the sequence, that is presented during that time segment may also relate to that person or place, or a category associated with that person or place, or a topic considered complimentary to that person or place, etc. Taxonomies, historical advertisement performance information, and historical user behavior information can be used to enhance advertisement selections. Additionally, any of many known forms of targeting may be employed as well, such as behavioral targeting, geotargeting, demographic targeting, interest targeting, etc.

In some embodiments, sequences are dynamically assembled, and can be modified or partially assembled part way through presentation of the sequence, based at least in part on user interaction with presented advertisements of the sequence. In this way, user engagement can be enhanced, since the user is involved in and actually affecting the sequence.

In some embodiments, a later or final advertisement or set of advertisements may in some way tie in with and connect together some or all previous advertisements in the sequence. For example, a final advertisement of a sequence may include assembled steps or elements of something associated with previous advertisements of a sequence, may provide results of user interaction with previous advertisements, may make reference to the sequence or to user participation, etc.

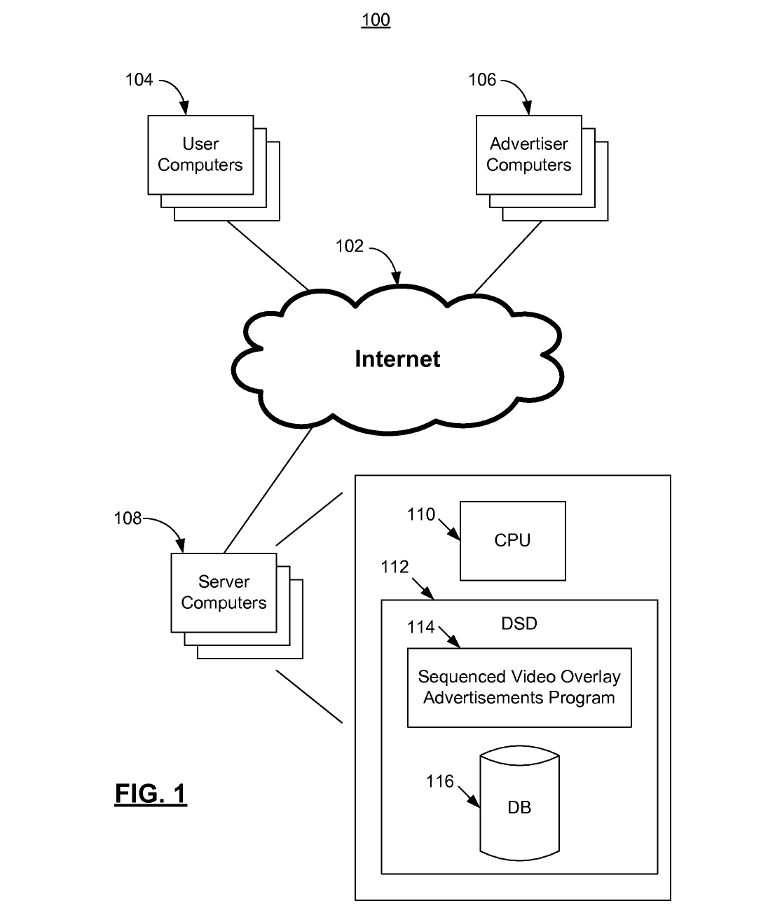

FIG. 1 is a distributed computer system 100 according to one embodiment of the invention. The system 100 includes user computers 104, advertiser computers 106 and server computers 108, all coupled or coupleable to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Sequenced Video Overlay Advertisements Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

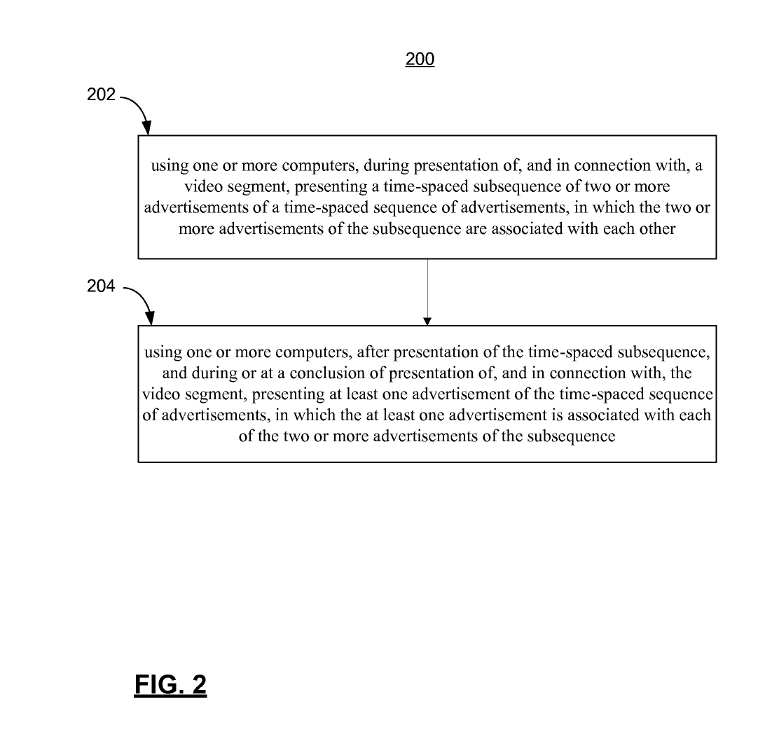

FIG. 2 is a flow diagram illustrating a method 200 according to one embodiment of the invention. At step 202, using one or more computers, during presentation of, and in connection with, a video segment, a time-spaced subsequence is presented of two or more advertisements of a time-spaced sequence of advertisements, in which the two or more advertisements of the subsequence are associated with each other.

At step 204, using one or more computers, after presentation of the time-spaced subsequence, and during or at a conclusion of presentation of, and in connection with, the video segment, at least one advertisement of the time-spaced sequence of advertisements is presented. The at least one advertisement is associated with each of the two or more advertisements of the subsequence.

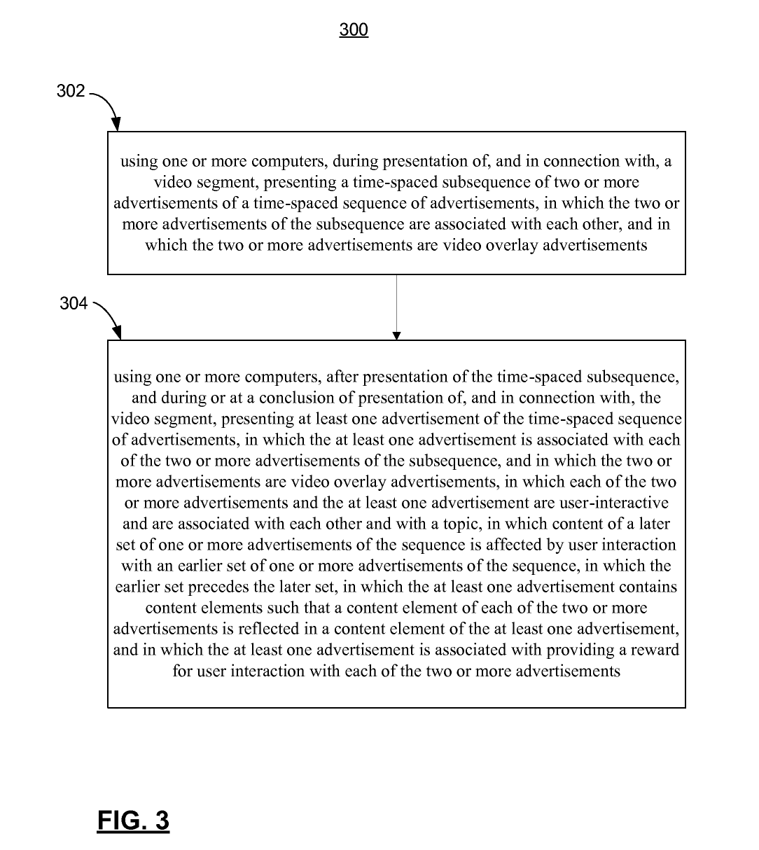

FIG. 3 is a flow diagram illustrating a method 300 according to one embodiment of the invention. Step 302 is similar to step 202 of FIG. 2.

At step 304, using one or more computers, after presentation of the time-spaced subsequence, and during presentation of, and in connection with, the video segment, at least one advertisement of the time-spaced sequence of advertisements is presented. The at least one advertisement is associated with each of the two or more advertisements of the subsequence. Furthermore, the two or more advertisements are video overlay advertisements. Each of the two or more advertisements and the at least one advertisement are user-interactive and are associated with each other and with a topic. Content of a later set of one or more advertisements of the sequence is affected by user interaction with an earlier set of one or more advertisements of the sequence, in which the earlier set precedes the later set. The at least one advertisement contains content elements such that a content element of each of the two or more advertisements is reflected in a content element of the at least one advertisement. Furthermore, the at least one advertisement is associated with providing a reward for user interaction with each of the two or more advertisements.

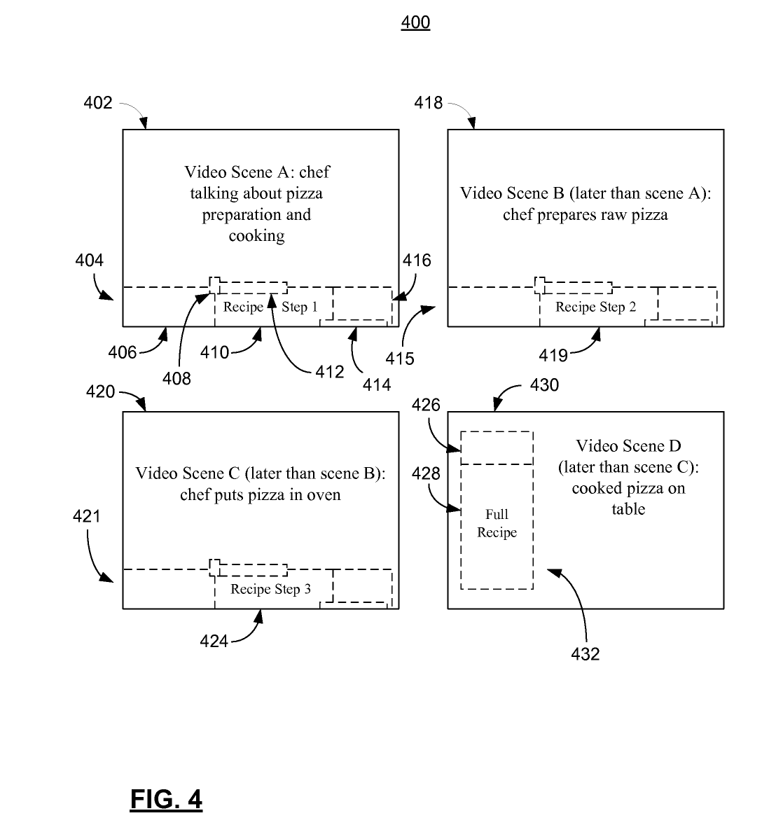

FIG. 4 is a simplified depiction of a sequence of advertisements 400 according to one embodiment of the invention. Specifically, FIG. 4 provides simplified depictions of screen shots 402, 418, 420, 430 relating to each of four increasingly later points in a video segment. At each of the four points, advertisements 404, 415, 421, 432 of a sequence of advertisements are presented.

Screen shot 402 includes an early scene from a cooking video, specifically, Video Scene A, including a chef talking about pizza preparation and cooking An overlay advertisement 404, according to one embodiment of the invention, appears toward the bottom of the screen. The overlay advertisement 404 includes a number of portions, including a brand advertising portion 406, a stick pin portion 408, a central portion 410, an upper portion 412, a lower right portion 414, and an upper right portion 416.

The brand advertising portion 406 can provide any form of brand advertising. In some embodiments, this includes a color graphic, the company name, and perhaps some additional information such as the company Web site. In some embodiments, the brand advertising portion 406, or other elements, can themselves include features such as miniature videos, for example. The brand advertising portion 406 may include functionality such that, for example, if selected, a browser is opened with the Web page of the company, or further advertisements are displayed, perhaps including non-overlay advertisements, etc.

The stick pin portion 416 may take any number of forms, such as an image of a stick pin. The stick pin portion 416 may have functionality, such as, if selected, keeping the overlay advertisement 404 on the screen, or saving it or a portion of it, etc.

The upper portion 412 may be some further type of advertising, such as a display stating, “click here to save”, and perhaps including functionality such as, if selected, causing display of further advertisements, coupons, discount offers, etc.

The central portion 410 includes the primary sequential, story-board type element of the overlay advertisement 404. The central portion 410 can include the text of a first step in a pizza recipe. The central portion 410 may include various fonts, colors, etc., and may include graphics. A topic of the content of the central portion 410 is associated with a topic of the screen shot 402 (pizza or pizza cooking)

The lower right portion 414, which is adjacent to the central portion 410 and the upper right portion 416, may include text that provides a tie-in between the central portion 410 and the upper right portion 416. For instance, the lower right portion 414 may include text stating, “Other recipe ideas”. The upper right portion 416 may provide a suggested other recipe, such as a dessert, and may include graphics, color, etc. The upper right portion 416 may include functionality such that, if selected, information is provided regarding the dessert, such as an additional advertisement, a browser, a microsite, etc.

As depicted, the central portion 410 may be the primary focus of the overlay advertisement 404. In some embodiments, the central portion 410 includes functionality. For instance, in some embodiments, a further overlay advertisement in the sequence may only be displayed, immediately or at a later time in the video, if a user selects or otherwise interacts with the central portion 410.

Screen shot 418 occurs after screen shot 404. Screen shot 418 includes Video Scene B, which includes a chef preparing raw pizza ingredients.

Overlay advertisement 415 is similar to overlay advertisement 404. However, at least, the central portion 419 is different. Specifically, the central portion 419 includes a second step in the recipe, which is a second part of the storyboard which began in overlay advertisement 404. In some embodiments, overlay advertisement 415 will not be displayed unless some form of user interaction or participation occurs in connection with previous overlay advertisement 404, for example, and the user may or may not be aware or made aware of this. The overlay advertisement 415 (as well as other overlay advertisements) may be timed to be associated with a topic of the video as well, or with both a topic of the video and a more specific topic of the screen shot 418.

Screen shot 420 occurs after screen shot 418. Screen shot 420 includes Video Scene C, specifically, including a scene of the chef placing the uncooked pizza in an oven. The overlay advertisement 421 is similar to the overlay advertisements 404, 415. However, at least, the central portion 424 is different. Specifically, the central portion 424 includes a third step in the recipe, which is a third part of the storyboard which began in overlay advertisement 404. In some embodiments, the overlay advertisement 421 will not be displayed unless some form of user interaction or participation occurs in connection with the previous overlay advertisement 415 or other previous advertisements, or both.

Screen shot 430 occurs after screen shot 420. Screen shot 430 includes Video Scene D, including a scene of a cooked pizza on a table. Overlay advertisement 432 is different in formatting than previous overlay advertisements, and includes brand advertising 426 and a lower portion 428. The lower portion 428 is a final advertisement in a sequence including previous overlay advertisements 404, 415, 421. The lower portion 428 includes a full pizza recipe, including the recipe steps included in previous overlay advertisements 404, 415, 421 of the sequence. The lower portion 428 may also include additional recipe or other information, information integrating or tying together the steps included in the previous overlay advertisements 404, 415, 421, as well as other information, and may include text, graphics, colors, etc.

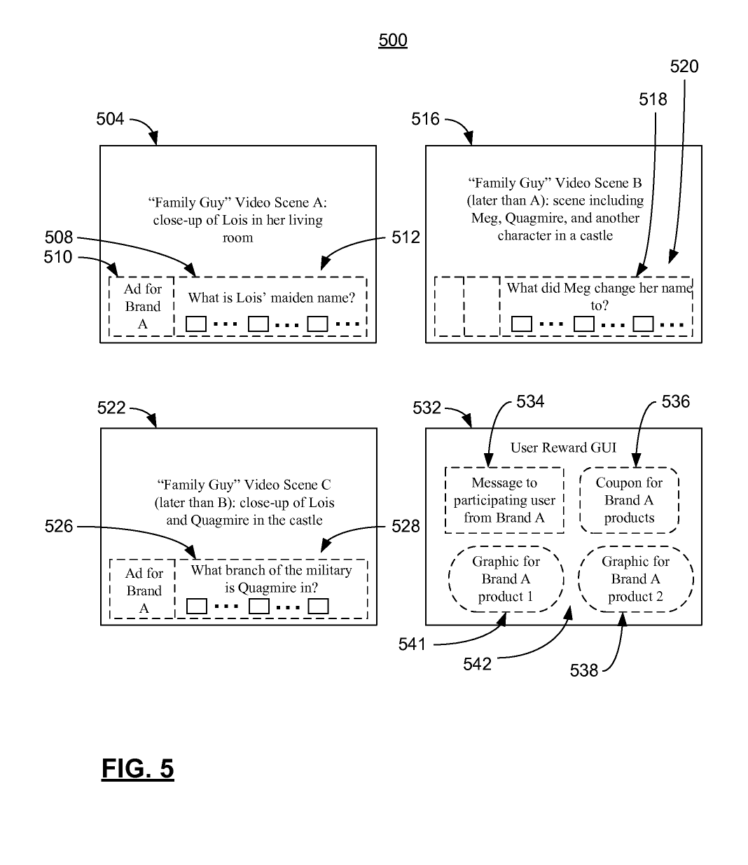

FIG. 5 is a simplified depiction of a sequence of advertisements 500 according to one embodiment of the invention. Specifically, FIG. 5 provides simplified depictions of screen shots 504, 516, 522, 532 relating to each of four increasingly later points in a video segment. At each of the four points, advertisements 512, 520, 528, 542 of a sequence of advertisements are presented as overlays.

The screen shot 504 includes a hypothetical early scene from the cartoon program, “Family Guy”, specifically, Video Scene A, a close-up of the character Lois in her living room. The overlay advertisement 512, according to one embodiment of the invention, appears toward the bottom of the screen. The overlay advertisement 512 includes a brand advertising portion 510 and a larger portion 508.

The brand advertising portion 510 can include branding-related text, graphics, colors, etc. It may include other elements, such as a tie-in with content of the screen shot 504 or of the larger portion 508. In this case, the larger portion 508 relates to a quiz game, and the brand advertising portion 510 may include tie-in text such as, “Quiz game sponsored by brand A”, etc. Brand A may be, for example, a food company that manufactures dessert products.

The larger portion 508 includes the first of a sequence of quiz questions associated with Family Guy. Specifically, the larger portion 508 invites the user to select one of several possible answers to the question, “What is Lois' maiden name”. Lois is a character from Family Guy, and is also depicted in the screen shot 504, so that the quiz question is very content-relevant.

Later screen shot 516 includes Video Scene B, which is a Family Guy scene including characters Meg, Quagmire, and another character in a castle setting. A larger portion 518 of the overlay advertisement 520 includes a further quiz question, specifically, “What did Meg change her name to”. The larger portion 518 continues the quiz that began with the previous overlay advertisement 512. In some embodiments, the overlay advertisement 520 may only be displayed if the user chooses an answer with regard to the previous quiz question.

A still later screen shot 522 includes Video Scene C, which is a Family Guy scene including a close-up of Lois and Quagmire in the castle. Overlay advertisement 528 includes a larger portion 526 with still another quiz question, specifically, “What branch of the military is Quagmire in?”

Still later screen shot 532 may be, for example, a user reward graphical user interface displayed only if the user participates in the entire quiz, and may be displayed, for example, at the end of the video. The screen shot 532 includes a message 534 to the participating user from Brand A, such as “Brand A thanks you for your participation! Here is your reward for a yummy treat!” The screen shot 532 also includes a portion 536 including a coupon for Brand A products, and two graphics 538, 541 which may depict particular Brand A dessert products. Various elements of the screen shot 532 may be user interactive, such as by allowing a browser to open to the Brand A Web site, etc.

Of course, FIGS. 4 and 5 depict only two of countless possibilities.

The foregoing description is intended merely to be illustrative, and other embodiments are contemplated within the spirit of the invention.

1. A method relating to advertising in connection with video, comprising:
using one or more computers, during presentation of, and in connection with, a video segment, presenting a time-spaced subsequence of two or more advertisements of a time-spaced sequence of advertisements, wherein each of the two or more advertisements of the subsequence is associated with a puzzle, and wherein each of the two or more advertisements may provide one of a plurality of pieces of the puzzle; and
using one or more computers, after presentation of the time-spaced subsequence, and during or at a conclusion of presentation of, and in connection with, the video segment, presenting at least one advertisement of the time-spaced sequence of advertisements, wherein the at least one advertisement presents at least some of the plurality of pieces of the puzzle.

2. The method of claim 1, comprising presenting the at least one advertisement, wherein the two or more advertisements of the subsequence are associated with each other, and wherein the at least one advertisement is associated with each of the two or more advertisements of the subsequence.

3. The method of claim 1, wherein each of the two or more advertisements presents one of the plurality of pieces of the puzzle if a user interacts with the advertisement.

4. The method of claim 1, wherein each of the two or more advertisements presents one of the plurality of pieces of the puzzle if a user interacts in a particular way with the advertisement.

5. The method of claim 1, wherein the at least one advertisement presents at least some of the plurality of pieces of the puzzle in an at least partially completed form.

6. The method of claim 1, wherein the at least one advertisement presents the puzzle in completed form.

7. The method of claim 1, wherein the at least one advertisement presents each of the plurality of pieces of the puzzle, and wherein the at least one advertisement provides a user with an opportunity to interact to assemble or assist in assembly of the puzzle from the plurality of pieces.

8. The method of claim 1, wherein each of the two or more advertisements and the at least one advertisement are user-interactive, and wherein content of a later set of one or more advertisements of the sequence is affected by user interaction with an earlier set of one or more advertisements of the sequence, wherein the earlier set precedes the later set.

9. The method of claim 1, wherein a particular advertisement of the sequence is displayed during a portion of the video segment such that subject matter of the portion of the video segment is associated with subject matter of the particular advertisement.

10. The method of claim 1, wherein each of the two or more advertisements and the at least one advertisement are part of a storyboard.

11. The method of claim 1, wherein each of the two or more advertisements and the at least one advertisement are user-interactive.

12. The method of claim 1, wherein presentation comprises display.

13. The method of claim 1, wherein the at least one advertisement contains content elements such that a content element of each of the two or more advertisements is reflected in a content element of the at least one advertisement.

14. The method of claim 1, wherein advertisements of the sequence are video overlay advertisements and are overlaid with regard to the video segment.

15. The method of claim 1, wherein user interaction with each of the two or more advertisements results in a reward, and wherein the at least one advertisement is associated with the reward.

16. The method of claim 15, wherein the reward comprises one or more coupons associated with a topic of, or content of, advertisements of the sequence.

17. The method of claim 15, wherein the reward comprises providing an ability to access premium online content.

18. The method of claim 1, wherein advertisements of the sequence comprise images.

19. A system for use in advertising in connection with video, comprising
one or more server computers coupled to the Internet; and
one or more databases coupled to the one or more server computers;
wherein the one or more server computers are for:
during presentation of, and in connection with, a video segment, presenting a time-spaced subsequence of two or more advertisements of a time-spaced sequence of advertisements, wherein each of the two or more advertisements of the subsequence is associated with a puzzle, and wherein each of the two or more advertisements may provide one of a plurality of pieces of the puzzle; and
after presentation of the time-spaced subsequence, and during or at a conclusion of presentation of, and in connection with, the video segment, presenting at least one advertisement of the time-spaced sequence of advertisements, wherein the at least one advertisement presents at least some of the plurality of pieces of the puzzle.

20. A computer readable medium or media containing instructions for executing a method relating to advertising in connection with video, the method comprising:
using one or more computers, during presentation of, and in connection with, a video segment, presenting a time-spaced subsequence of two or more advertisements of a time-spaced sequence of advertisements, wherein each of the two or more advertisements of the subsequence is associated with a puzzle, and wherein each of the two or more advertisements provides one of a plurality of pieces of the puzzle if the user interacts with the advertisement; and
using one or more computers, after presentation of the time-spaced subsequence, and during or at a conclusion of presentation of, and in connection with, the video segment, presenting at least one advertisement of the time-spaced sequence of advertisements, wherein the at least one advertisement presents the puzzle in a completed form.
